(19) United States
(12) Patent Application Publication
(10) Pub. No.: US 2008/0270643 A1
(43) Pub. Date: Oct. 30, 2008

(54) TRANSFER SYSTEM, INITIATOR DEVICE, AND DATA TRANSFER METHOD

(75) Inventor: Naomitsu TASHIRO, Oi (JP)

Correspondence Address: SUGHRUE MION, PLLC, 2100 PENNSYLVANIA AVENUE, N.W., SUITE 800, WASHINGTON, DC, 20037, US

(73) Assignees: HITACHI, LTD., Chiyoda-ky (JP); Hitachi Computer Peripherals Co., Ltd., Ashigarakami-gun (JP)

(21) Appl. No.: 12/013,834

(22) Filed: Jan. 14, 2008

(30) Foreign Application Priority Data
Apr. 24, 2007 (JP) 2007-114266

(51) Int. Cl. G06F 13/18

(52) U.S. Cl. 710/35

(57) ABSTRACT

An object of the invention is to provide a transfer system, initiator device, and data transfer method that can improve data transfer-related performance by fully utilizing a high-speed interface even when transferring data between devices that execute data processing at different speed.

The invention provides a transfer system including: an initiator device, plural target devices, and a switch for switching data transfer targets between the initiator device and target devices, wherein either the initiator device or the target devices are connected to the switch via a high-speed interface and the other is connected to the switch via a low-speed interface, and the initiator device has a control unit for determining the data transfer length of data transferred to a first target device in the target devices according to the status of data transfer to the other target device(s) when transferring data between the initiator device and the first target device.

### CROSS-REFERENCES TO RELATED APPLICATIONS

This application relates to and claims priority from Japanese Patent Application No. 2007-114266, filed on Apr. 24, 2007, the entire disclosure of which is incorporated herein by reference.

### BACKGROUND

1. Field of the Invention

The invention relates to a transfer system, an initiator device, and a data transfer method, more particularly to a technique for optimizing data transfer size during multiple-target data transfer.

2. Description of Related Art

The amount of data transferred from the low-speed devices to the high-speed devices passes firstly through a low-speed interface and secondly through a high-speed interface with data transfer-related performance being not restricted by the high-speed interface bandwidth during multiple-target data transfer between a high-speed device used as an initiator connected to a high-speed interface that enables high-speed data transfer and low-speed devices used as targets each connected to a low-speed interface that transfers data at low speed.

Various techniques for improving the data transfer-related performance during data transfer such as that described above by efficiently optimizing data transfer size are being developed.

JP-A-2001-256171 discloses a technique for setting, when transferring data between modules in a computer, the size of the data transferred by a target module per time unit to a maximum transferable size determined in light of both modules' transfer performance, and controlling data transfer so that only data of the above determined maximum transferable size is transferred between a master module and a target module.

JP-A-04-340643 discloses a technique for controlling data transfer between a host and an I/O device so that data of the most convenient size for the host can be transferred by specifying that most convenient data transfer size to the I/O device if the I/O device has a data transfer size changer with which data transfer size can be changed during data transfer.

JP-A-05-046325 discloses a technique for controlling, during data transfer between a host and a tape backup device with a buffer, a variable length buffer size by determining an optimum buffer size based on the time taken for transferring data of buffer size.

However, the data transfer size used during multiple-target data transfer is not considered in the above described techniques.

Meanwhile, the amount of data transferred from the high-speed device to the low-speed devices eventually passes through the respective low-speed interfaces during data transfer between a high-speed device and low-speed devices, but the data transfer-related performance is restricted by the low-speed interface bandwidth. Therefore, the data transfer speed from the high-speed device to the low-speed devices is lowered.

As a result, the total data transfer-related performance deteriorates.

The present invention was made in light of the above problem, and provides a transfer system, an initiator device, and a data transfer method capable of improving data transfer-related performance by fully utilizing the high-speed interface, even when data is transferred between devices that execute data processing at different speeds.

### SUMMARY

To solve the above problem, the invention provides a transfer system including: an initiator device; a plurality of target devices; and a switch for switching the data transfer target between the initiator device and the plurality of target devices. In the transfer system, either the initiator device or the plurality of target devices is connected to the switch via a high-speed interface, and the other is connected to the switch via a low-speed interface. The initiator device has a control unit for determining, according to the status of data transfer to the target device(s) other than a first target device, the data transfer length used for transferring data to the first target device when data is transferred between the initiator device and the first target device.

With the above transfer system, the initiator device can set the optimum data transfer length for data transfer between the initiator device and the target devices.

The invention also provides an initiator device connected, via a high-speed or low-speed interface, to a switch for switching the data transfer target between the target devices. The initiator device includes a control unit for determining, according to the status of data transfer to the target device(s) other than a first target device, the data transfer length used for transferring data to the first target device when transferring data to the first target device.

With the above initiator device, the initiator device can set the optimum data transfer length used for data transfer between the initiator device and the target devices.

The invention also provides a method for transferring data between an initiator device and a plurality of target devices, either the initiator device or the target devices being connected, via a high-speed interface, to a switch for switching data transfer targets between the initiator device and the target devices, and the other being connected to the switch via a low-speed interface, the method including: controlling data transfer by determining, according to the status of data transfer to the target device(s) other than a first target device, the data transfer length used for transferring data to the first target device when transferring data between the initiator device and the first target device.

With the above method, the initiator device can set the optimum data transfer length used for data transfer between the initiator device and the target devices.

Using the invention, data transfer-related performance can be improved by fully utilizing the high-speed interface bandwidth to set the optimum data transfer length during multiple-target data transfer even when data is transferred between devices that execute data processing at different speed.

Also, using the invention, the control unit provided in the initiator device can set the optimum data transfer length according to the status of data transfer from the initiator device to the target devices.

### BRIEF DESCRIPTION OF THE DRAWINGS

FIG. 1 is a block diagram showing the overall configuration of a transfer system used in a first embodiment.

FIG. 2 is a diagram showing the content of memory in a high-speed device used in the first embodiment.

FIG. 3 is a diagram showing a burst transfer data length management table used in the first embodiment.

FIG. 4 is a diagram illustrating data transfer from low-speed devices to a high-speed device according to the first embodiment.

FIG. 5 is a diagram illustrating data transfer from a high-speed device to low-speed devices according the first embodiment.

FIG. 6 is a graph representing transfer system performance during data transfer according to the first embodiment.

FIG. 7 is a diagram showing a basic data transfer sequence executed between the high-speed device and one of the low-speed devices.

FIG. 8 is a conceptual diagram showing commands and data processing in each low-speed device in the first embodiment.

FIG. 9 is a conceptual diagram showing commands and data processing in each low-speed device in the first embodiment.

FIG. 10 is a conceptual diagram showing commands and data processing in each low-speed device in the first embodiment.

FIG. 11 is a flowchart illustrating processing for setting the burst transfer data length executed according to the first embodiment.

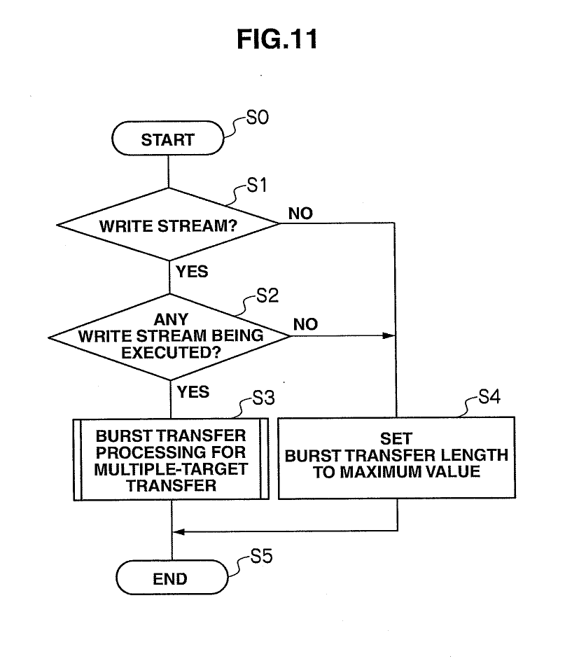

FIG. 12 is a flowchart illustrating processing for determining the minimum effective burst transfer data length executed according to the first embodiment.

FIG. 13 is a graph representing the speed performance of a low-speed interface in the first embodiment.

FIG. 14 is a flowchart illustrating processing for determining the transferable burst transfer data length executed according to the first embodiment.

FIG. 15 is a flowchart illustrating processing for determining the burst transfer data length for multiple-target data transfer executed according to the first embodiment.

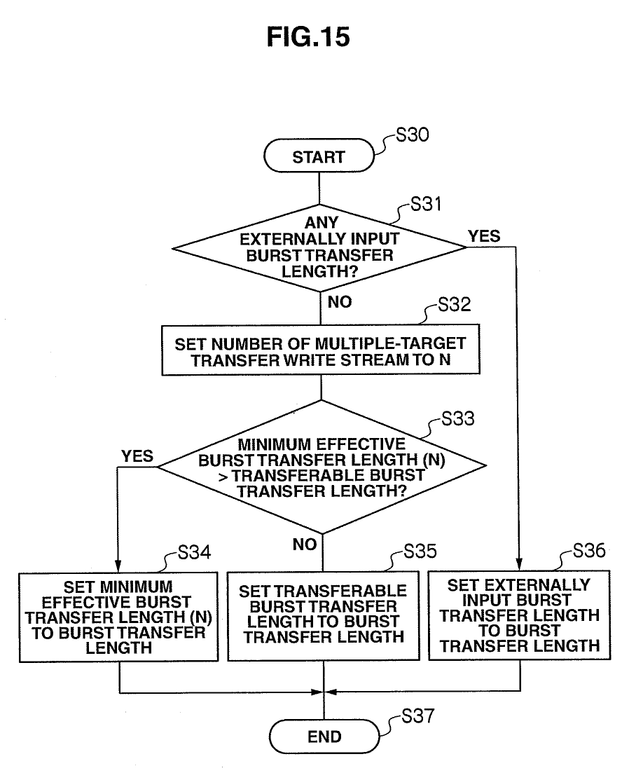

FIG. 16 is a block diagram showing the overall configuration of a transfer system used in a second embodiment.

FIG. 17 is a block diagram showing the overall configuration of a transfer system used in a third embodiment.

### DETAILED DESCRIPTION OF PREFERRED EMBODIMENTS

### (1) First Embodiment

(1-1) Transfer System

First, a transfer system in this embodiment will be described below.

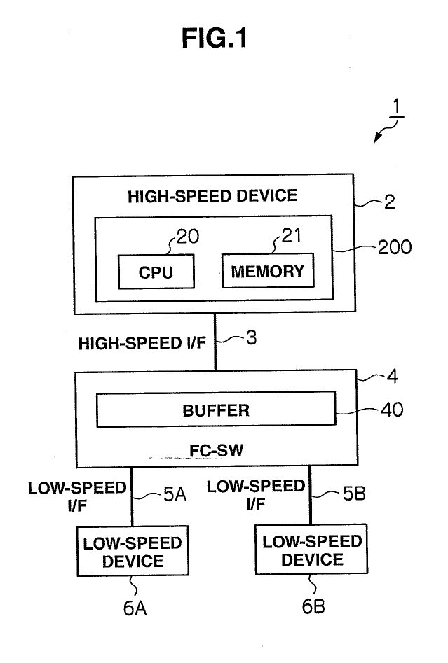

Referring to FIG. 1, reference number 1 denotes the entire transfer system that executes the data transfer method according to this embodiment. The burst transfer method in which plural units of data are sequentially transferred based on single address information is employed as the data transfer method in this embodiment.

In the transfer system 1, a high-speed device 2 is connected to a switch 4 having a buffer 40 via a high-speed interface that enables high-speed data transfer, and the switch 4 is connected to low-speed devices 6A and 6B respectively via low-speed interfaces 5A and 5B that enable low-speed data transfer.

In the transfer system 1 in this embodiment, the high-speed device 2 is provided as an initiator device, and the low-speed devices 6 are provided as target devices.

The high-speed device 2 includes a control unit 200 having a CPU (Central Processing Unit) 20 and memory 21, etc. The high-speed device 2 is a memory device that controls data I/O and is able to execute data processing at high speed. The details of the high-speed device 2 will be described later.

The high-speed interface 3 is an interface for transferring data at high speed between the high-speed device 2 and the switch 4. Examples of the high-speed interface 3 in this embodiment include a Fibre Channel interface, which transfers data at a high interface speed of 4 Gb/s.

The switch 4 transfers data by switching, exchanging data from the high-speed device and data and commands from the low-speed devices. The switch 4 includes a buffer 40 for storing data sent from the high-speed device of low-speed devices.

The low-speed interfaces 5A and 5B are interfaces for transferring data at low speed between each of the low-speed devices 6A and 6B and the switch 4. Examples of the low-speed interfaces 5A and 5B in this embodiment include a Fiber Channel interface, which transfers data at a low interface speed of 2 Gb/s. The low-speed interfaces 5A and 5B are referred to collectively as the low-speed interfaces 5, except when the distinction between them needs to be made.

Each of the low-speed devices 6A and 6B is a storage device including information processing resources such as a CPU (Central Processing Unit) and memory. The low-speed devices 6A and 6B are referred to collectively as the low-speed devices 5, except when the distinction between them needs to be made.

In this embodiment, one initiator device and two target devices are used. However, the number of the devices is not limited to that, and any number may be used if multiple-target data transfer can be executed between the initiator device(s) and the target device(s).

Both the high-speed interface and the low-speed interface can be used as either the initiator device interface or the target device interface. Those interfaces adjust their own processing speed to that of the device they are attached to.

(1-2) High-Speed Device Configuration

Next, the configuration for the high-speed device 2 will be described.

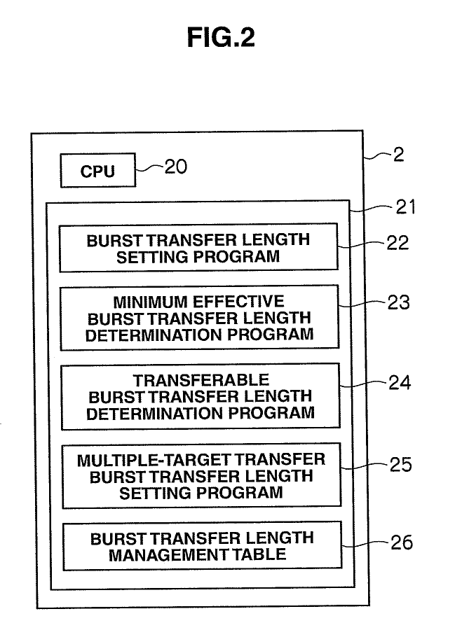

FIG. 2 is a diagram showing the content of the high-speed device 2.

The high-speed device 2 includes, in its control unit 200, a CPU 20 for executing various programs and memory 21 for storing those programs.

The memory 21 stores a burst transfer data length setting program 22 for determining the optimum burst transfer data length, a minimum effective burst transfer data length determination program 23 for determining the minimum effective value of burst transfer data length, a transferable burst transfer data length determination program 24 for determining length of data that can be transferred within a unit of time at the data transfer speed of low-speed interface 5, a multiple-target data transfer burst transfer data length setting program 25 for determining the optimum burst transfer data length for multiple-target data transfer while write processing is being executed, and a burst transfer data length management table 26 for managing values concerning the burst transfer data lengths determined according to the programs 23 and 24.

(1-3) Burst Transfer Data Length Management Table

Next, the burst transfer data length management table will be described.

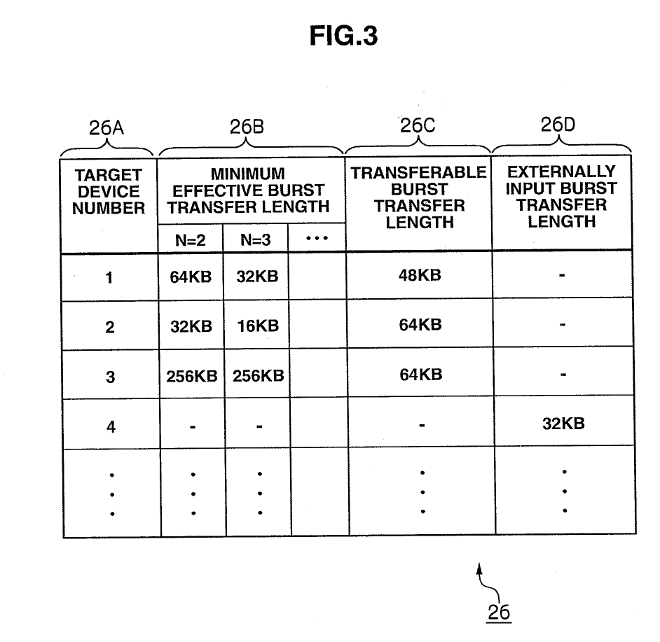

FIG. 3 is a diagram showing the burst transfer data length management table.

The burst transfer data length management table 26 is a table for storing information used for determining the data transfer length for multiple-target data transfer.

The information used for determining the data transfer length for multiple-target data transfer is values concerning the burst transfer data lengths determined based on the minimum effective burst transfer data length determination program 23 for determining the minimum effective value for burst transfer data length and the transferable burst transfer data length determination program 24 for determining the burst transfer data length of data that can be transferred during FCP_XFER_RDY response time.

The burst transfer data length management table contains a “target device number” field 26A, a “minimum effective burst transfer data length” field 26B, a “transferable burst transfer data length” field 26C and an “externally input burst transfer data length” field 26D.

The “target device number” field 26A stores the target device numbers. In this embodiment, the device numbers for the low-speed devices 6, which are set as the target devices, are stored.

The “minimum effective burst transfer data length” field 26B stores the minimum effective values of burst transfer data length determined based on the minimum effective burst transfer data length determination program 23. “N” in the “minimum effective burst transfer data length” field 26B represents the number of multiple-target data transfer write streams, indicating the number of devices targeted by multiple-target data transfer from the initiator device. In this embodiment, N is the number of the low-speed devices 6 targeted by multiple-target data transfer from the high-speed device 2.

The “transferable burst transfer data length” field 26C is a field to which values determined according to the transferable burst transfer data length determination program 24 are input, and the field 26C stores the burst transfer data length of data transferred within the FCP_XFER_RDY response time.

The “externally input burst transfer data length” field 26D stores burst transfer data length values input by an external user.

(1-4) Data Transfer

First, data transfer executed in a transfer system 1 configuration in which the invention is not used will be described. In the following explanation, the transfer system 1 in which the invention is not used also includes a high-speed device 2 set as an initiator device and low-speed devices 6 set as target devices.

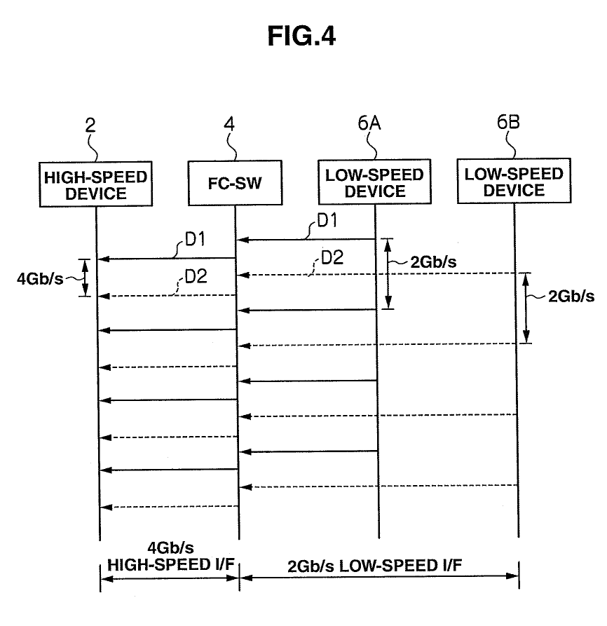

FIG. 4 is a diagram showing data transfer from the low-speed devices 6 to the high-speed device 2. Full-line arrows represent data transfer from the low-speed device 6A to the high-speed device 2, and broken-line arrows represent data transfer from the low-speed device 6B to the high-speed device 2.

More specifically, the low-speed device 6A transfers data D1 to the switch 4 via the low-speed interface 5A, which has a 2 Gb/s data transfer speed. The switch 4, after receiving the data D1 at the buffer 40, transfers the data D1 to the high-speed device 2 via the high-speed interface 3, which has a 4 Gb/s data transfer speed.

Similarly, the low-speed device 6B transfers data D2 to the switch 4 via the 2 Gb/s low-speed interface 5B, and the switch 4 transfers the data D2 to the high-speed device 2 via the 4 Gb/s high-speed interface 3.

When data is transferred from the low-speed devices 6 to the high-speed device 2 as above, data is first transferred from the low-speed devices 6 at 2 Gb/s, and then data is transferred to the high-speed device 2 at 4 Gb/s. Accordingly, the performance of the transfer system 1 does not deteriorate.

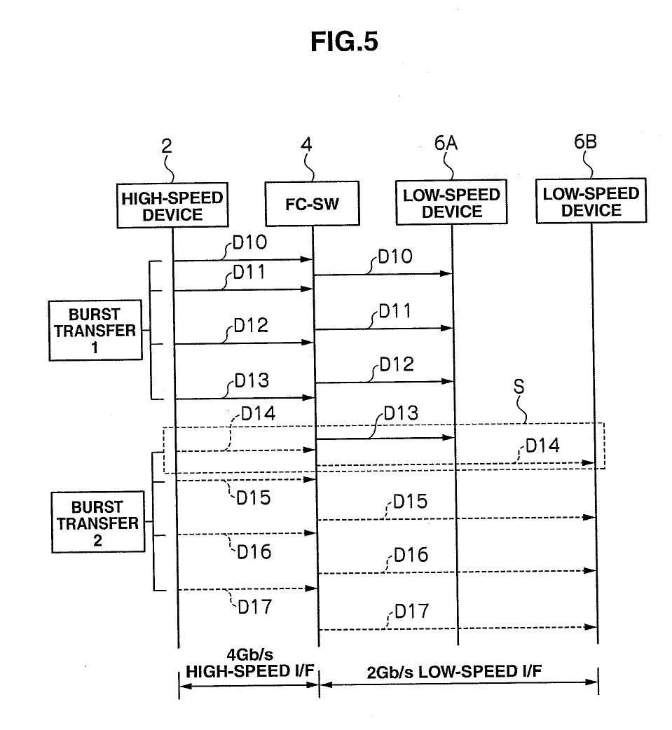

FIG. 5 is a diagram showing data transfer from the high-speed device 2 to the low-speed devices 6. Actual line arrows represent data transfer from the high-speed device 2 to the low-speed device 6A, and broken line arrows represent data transfer from the high-speed device 2 to the low-speed device 6B.

More specifically, the high-speed device 2 transfers first data D10 to the switch 4. The switch 4 receives the first data D10 at the buffer 40, and transfers the first data D10 from the buffer 40 to the low-speed device 6A. Then the high-speed device 2 transfers second data D11 to the switch 4 at 4 Gb/s. Part of the first data D10 that could not be transferred to the low-speed device 6A during the above data transfer remains in the buffer 40 at the point in time when the buffer 40 receives the second data D1, so the buffer 40 is temporarily filled up with the amount of data and becomes unable to store extra data. Accordingly, the switch 4 transfers the second data D11 to the low-speed device 6A at 2 Gb/s. Subsequent data D12 and D13 have to wait until data space in the buffer 40 becomes available, so the data D12 and D13 are transferred from the high-speed device 2 to the switch 4 at 2 Gb/s.

After finishing all burst transfers to the low-speed device 6A, the high-speed device 2 switches the data transfer target to the low-speed device 6B.

The high-speed device 2 transfers first data D14 to switch 4 to forward it to the low-speed device 6B. The switch 4 receives the first data D14 at the buffer 40, and transfers the first data D14 from the buffer 40 to the low-speed device 6B. The data transfer target is then switched from the low-speed device 6A to the low-speed device 6B, and the first data D14 is transferred from the switch 4 to the low-speed device 6B. The high-speed device 2 next transfers second data D15 to the switch 4 at 4 Gb/s. Since part of the first data D14 that could not be transferred to the low-speed device 6B during the above data transfer remains in the buffer 40 at the point in time when the buffer 40 receives the second data D15, the switch 4 transfers the second data D15 to the low-speed device 6B at 2 Gb/s. Subsequent data D16 and D17 are also transferred from the high-speed device 2 to the switch 4 at 2 Gb/s.

As described above, when data is transferred from the high-speed device to the low-speed devices in the above described transfer system 1, the data D12, D13, D16, and D17, which are to be sequentially transferred from the high-speed device 4, can be transferred at 2 Gb/s because of the difference in interface data transfer speed. Therefore, the bandwidth of the high-speed interface cannot be fully utilized.

At the point in time where the data transfer target is switched, the fourth data D13 and the first data D14 are transferred at 4 Gb/s. Accordingly, to fully utilizing the high-speed interface bandwidth, it is necessary to shorten the burst transfer data length and increase the number of times the transfer target device is switched.

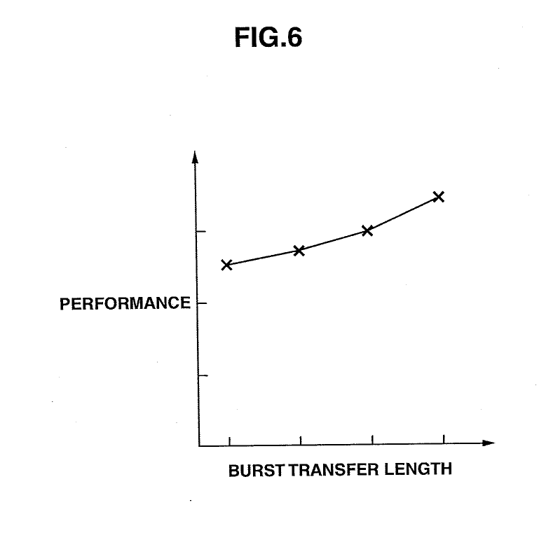

FIG. 6 is a graph showing the data transfer-related performance of the transfer system 1. The vertical axis represents performance of the transfer system 1, and the horizontal axis represents burst transfer data length. According to FIG. 6, the data transfer-related performance of the transfer system 1 deteriorates 1 if the burst transfer data length is set to be too short.

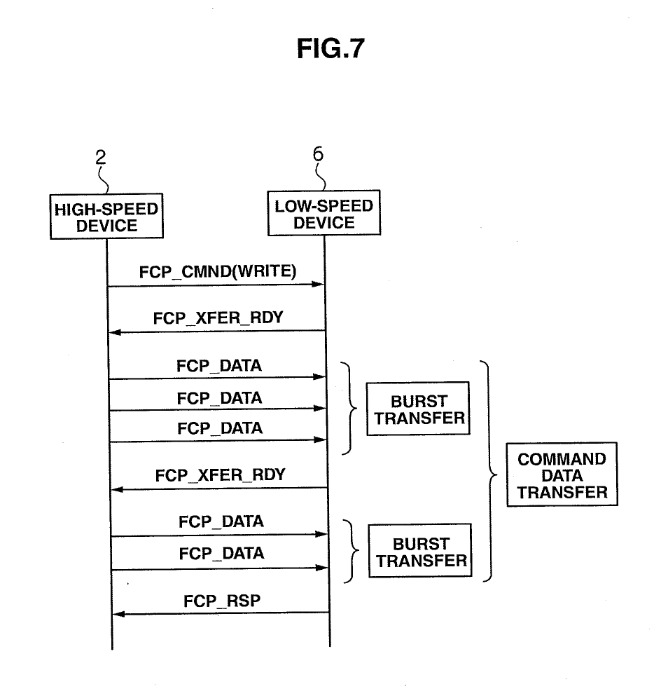

FIG. 7 is a diagram showing a basic data transfer sequence executed between the high-speed device 2 and one of the low-speed devices 6. FIG. 7 illustrates data transfer from the high-speed device 2 to the low-speed device 6.

First, the high-speed device 2 sends a write command to the low-speed device 6 (‘FCP_CMND’ (WRITE) in FIG. 7). The low-speed device 6, after receiving the write command, notifies the high-speed device 2 of the burst transfer data length, i.e., the length of data the high-speed device 2 can transfer at a time (‘FCP_XFER_RDY’ in FIG. 7). The time taken from when the high-speed device 2 sends a write command to the low-speed device 6 until it receives a FCP_XFER_RDY notice is referred to as the “FCP_XFER_RDY response time.”

The high-speed device 2, after receiving the notice, sends data for the burst transfer data length the high-speed device 2 can send during a one-time transfer based on the notice. In this system, the high-speed device 2 cannot send data until it has received the FCP_XFER_RDY notice from the low-speed device 6.

After the high-speed device 2 finishes sending data for the data transfer length the high-speed device 2 can send during a one-time burst transfer (‘FCP_DATA’ in FIG. 7), the low-speed device 6 again notifies the high-speed device 2 of the burst transfer data length that is the length of data the high-speed device 2 can send during a one-time burst transfer (‘FCP_XFER_RDY’ in FIG. 7).

The high-speed device 2 then sends, to the low-speed device 6, data for the data transfer length the high-speed device 2 can send during a one-time burst transfer (‘FCP_DATA’ in FIG. 7). This sending processing is repeated until all data are sent to the low-speed device 6. The low-speed device 6, after receiving all data, notifies the high-speed device 2 of termination status (‘FCP_RSP’ in FIG. 7). All data burst transferred after the high-speed device 2 issues a write command until it receives the termination status is referred to as “command data”.

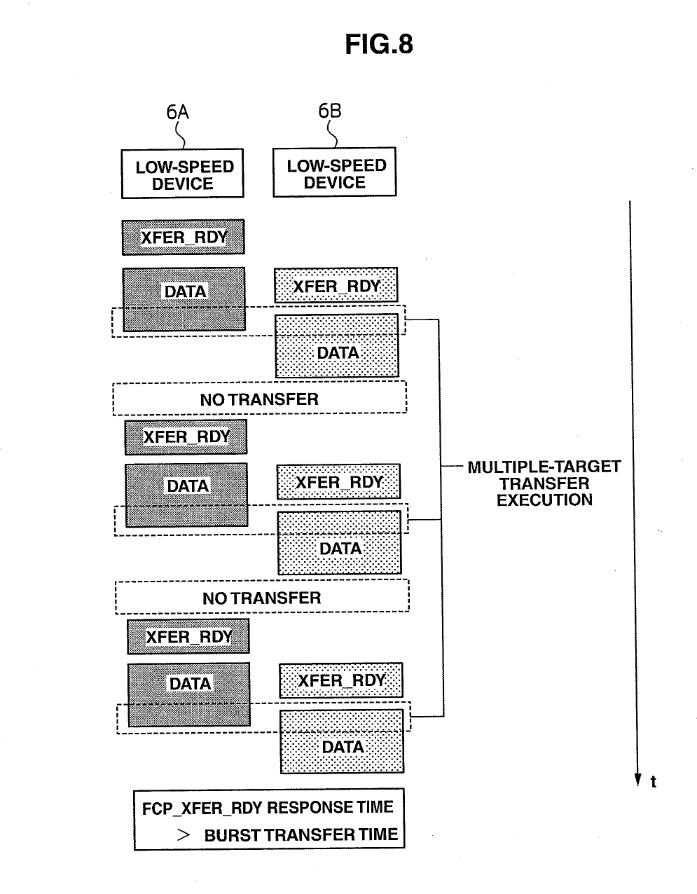

FIGS. 8 to 10 are conceptual diagrams illustrating command and data processing executed by the low-speed devices 6A and 6B after receiving a write command and data from the high-speed device 2. In the figures, the vertical axis is a time axis t. Portions enclosed with broken lines represent periods of time where multiple-target data transfer is executed. In the portions where multiple-target data transfer can be executed, data can be transferred at 4 Gb/s, as has already been explained with reference to FIG. 5.

For example, if the burst transfer time is shorter than the FCP_XFER_RDY response time, no data transfer is executed during some periods of time (such periods of time are referred to as ‘no-transfer times’). The high-speed device 2 cannot send data until the low-speed device 6A sends the FCP_XFER_RDY notice to the high-speed device 2, so a no-transfer time is generated between when the low-speed device 6B receives data and when the low-speed device 6A sends the FCP_XFER_RDY notice to the high-speed device. The performance of the transfer system 1 deteriorates because of the no-transfer time.

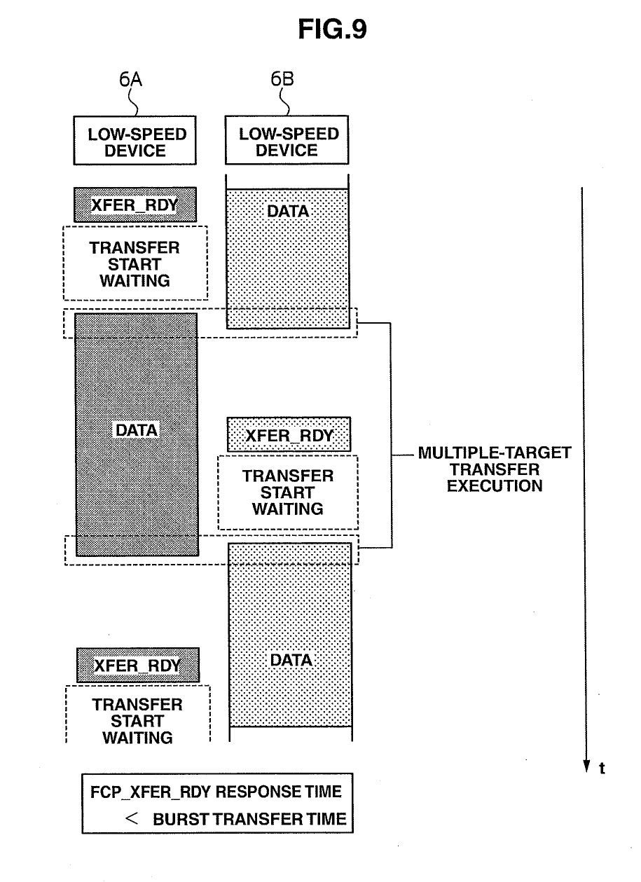

If the burst transfer time is longer than the FCP_XFER_RDY response time, the low-speed devices 6 waits for the start of data transfer during some periods of time (such periods of time are referred to as ‘transfer start waiting times’), as shown in FIG. 9. Because the low-speed device 6A has sent an FCP_XFER_RDY notice to the high-speed device 2 but the low-speed device 6B has not finished receiving data, the transfer start waiting time is generated in the low-speed device 6A. Therefore, multiple-target data transfer can be executed only at a few points in time. Meanwhile, the data received by the low-speed device 6B is transferred at 2 Gb/s because the data go through the low-speed interface, and so the performance of the transfer system 1 deteriorates.

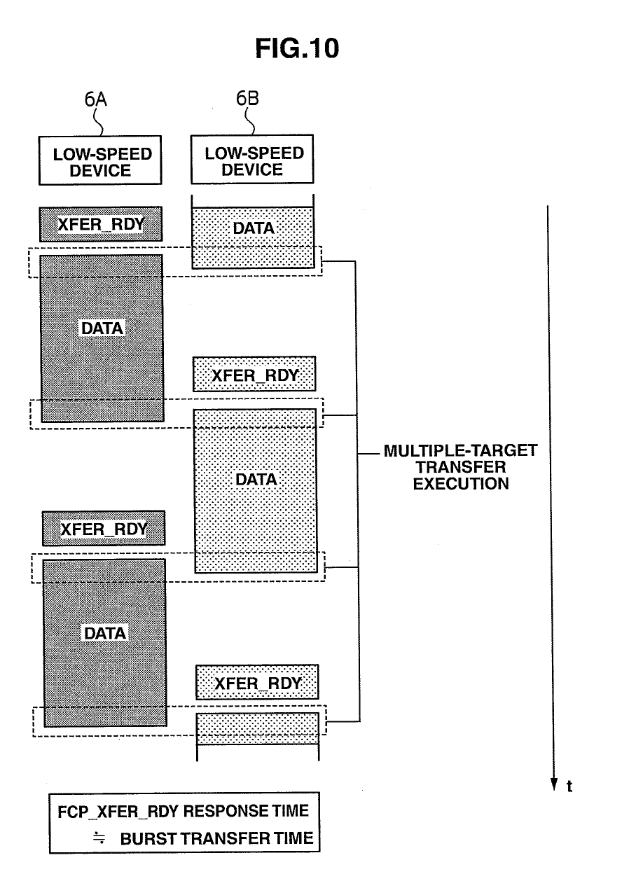

If the FCP_XFER_RDY response time is substantially the same as the burst transfer time, no no-transfer time or transfer start waiting time is generated as shown in FIG. 10. Data is transferred from the high-speed device 2 just after the low-speed device 6A sends the FCP_XFER_RDY notice to the high-speed device 2. The point in time where the low-speed device 6A starts receiving transferred data corresponds to the point in time where the low-speed device 6B finishes receiving transferred data, and the multiple-target data transfer is performed at that point in time. Therefore, the high-speed interface is fully utilized and the performance of the transfer system 1 does not deteriorate.

(1-5) Functions for Setting Burst Transfer Data Length

In the transfer system 1 in this embodiment, an initiator device can set the optimum data transfer length (burst transfer data length) so that multiple-target data transfer is executed without no-transfer time or transfer start waiting time during the processing executed by the target devices.

Next, how the above described characteristics of the present invention are realized will be described below.

(1-5-1) Burst Transfer Data Length Setting Processing

First, “burst transfer data length setting processing” executed by the high-speed device 2 for setting the optimum burst transfer data length will be described. The burst transfer data length setting processing is executed by the CPU 20 in the high-speed device 2 based on the burst transfer data length setting program 22.

More specifically, the CPU 20 in the high-speed device 2 starts the burst transfer data length setting processing immediately before transferring stream data to the low-speed devices 6 (S0).

Next, the CPU in the high-speed device 2 checks whether or not the data transfer is write stream (S1).

“Write stream” means sequential transfer of a large volume of data, beginning with the data head, from the high-speed device 2 to the low-speed devices 6.

If the data transfer is write stream (S1: YES), the CPU 20 in the high-speed device 2 checks whether or not another write stream to the other low-speed device 6 is being executed (S2). In other words, the CPU 20 in the high-speed device 2 checks whether or not any other data is being transferred from the high-speed device 2 to the other low-speed device 6.

If another write stream is being executed for the other low-speed devices 6 (S2: YES), the CPU 20 in the high-speed device 2 executes the burst transfer processing for multiple-target data transfer to set the burst transfer data length to a value for the multiple-target data transfer, thereby setting an optimum burst transfer data length (S3), and terminates the burst transfer data length setting processing (S5). The burst transfer processing for multiple-target data transfer will be described later.

Meanwhile, if, in step S1, the data transfer is not write stream but data transfer from the low-speed device 6 to the high-speed device 2 (S1: NO), the CPU 20 in the high-speed device 2 sets the burst transfer data length to the maximum value predetermined for each device (S4), and terminates the burst transfer data length setting processing (S5).

If, in step S2, write stream to the other low-speed device 6 is not being executed (S2: NO), i.e., if no other data is being transferred from the high-speed device 2 to the other low-speed device 6 (S2: NO), the CPU 20 in the high-speed device 2 sets the burst transfer data length to the predetermined maximum value (S4), and terminates the burst transfer data length setting processing (S5).

If there is no data targeted by multiple-target data transfer from the high-speed device 2 to the other low-speed device 6 (S1: N0 and S2: NO), deterioration in the performance of the transfer system 1 can be prevented by setting the burst transfer data length to the maximum burst transfer data length value predetermined for each device.

(1-5-2) Minimum Effective Burst Transfer Data Length Determination Processing

Next, the CPU 20 in the high-speed device 2 calculates a minimum effective value that does not deteriorate the performance of the transfer system 1 in light of the graph representing the performance of the transfer system 1 by executing “minimum effective burst transfer data length determination processing.” The minimum effective burst transfer data length determination processing is executed by the CPU 20 in the high-speed device 2 according to the minimum effective burst transfer data length.

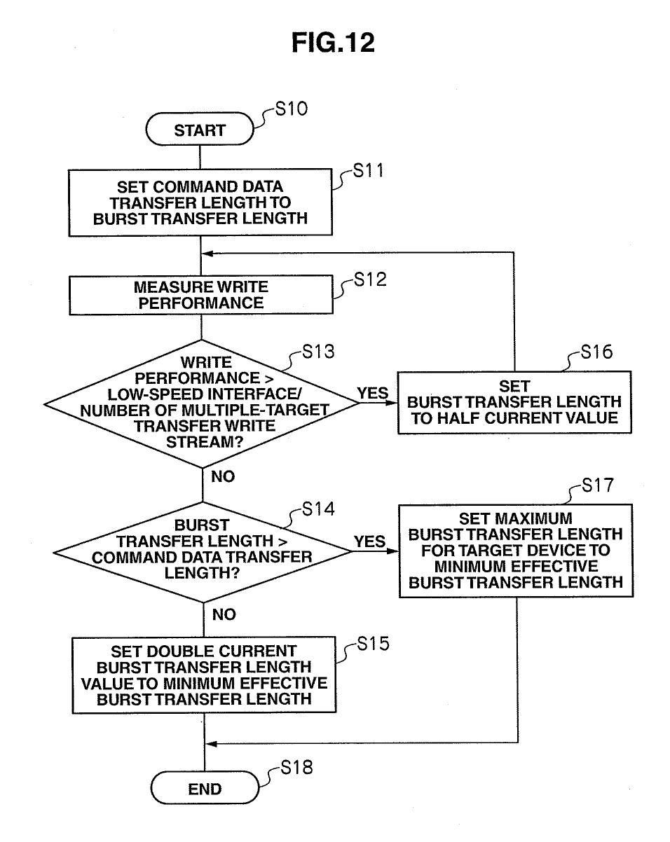

More specifically, as shown in FIG. 12, the CPU 20 in the high-speed device 2 starts the minimum effective burst transfer data length determination processing, as required (e.g., when the device is started up). (S10).

Next, the CPU 20 in the high-speed device 2 sets the burst transfer data length to an initial value, as a command data transfer length, which is the length of data transferred in response to a command.

The CPU 20 in the high-speed device 2 then measures write performance (S12). The write performance is the data transfer speed at which data from the high-speed device is written to the low-speed device.

The CPU 20 in the high-speed device 2 checks whether or not the write performance is higher than the data transfer speed of the low-speed interface connected to each write stream target low-speed device (S13).

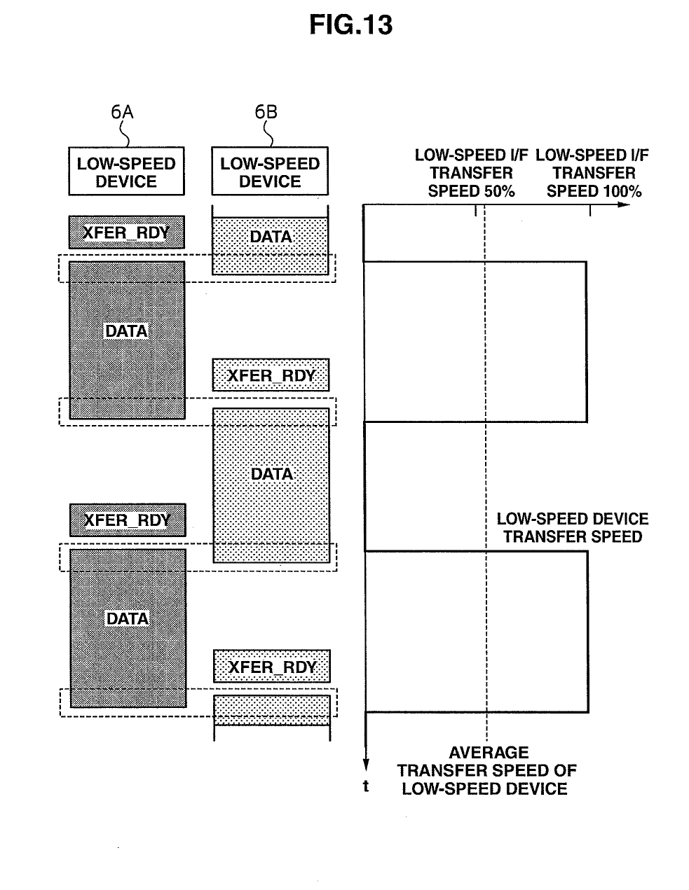

The speed performance of the low-speed interface 5A will be described with reference to the graph in FIG. 13. In the graph, the horizontal axis represents the transfer speed of the low-speed interface 5A, and the vertical axis is the time axis t. FIG. 13 illustrates the relationship between the speed performance of the low-speed interface 5A and the data processing executed by the low-speed devices 6 illustrated in FIG. 10.

In order to execute multiple-target data transfer, including simultaneous transfer, from the high-speed device 2 to low-speed devices 6, the average transfer speed during write stream transfer from the high-speed device 2 to each low-speed device 6 has to be equal to or higher than the data transfer speed of the low-speed interface connected to each write stream target low-speed device. If the average data transfer speed from the high-speed device to the low-speed devices is below the data transfer speed of each write stream target low-speed interface, a time period where no data is transferred to the low-speed devices is generated, and the high-speed interface bandwidth cannot be fully utilized.

Accordingly, in order to improve the performance of the transfer system 1 relating to the multiple-target data transfer, the multiple-target data transfer is performed only when the average transfer performance during the data transfer from the high-speed device to the low-speed devices exceeds the data transfer speed of the low-speed interface connected to each write stream target low-speed device in the check in step S13.

Referring back to FIG. 12, if the write performance is not higher than the data transfer speed of the low-speed interface connected to each write stream target low-speed devices (S13: NO), the CPU 20 in the high-speed device 2 checks whether or not the burst transfer data length is equal to the command data transfer length (S14).

If the burst transfer data length is not equal to the command data transfer length (S14: NO), the CPU 20 in the high-speed device 2 sets a transfer length that is double the current burst transfer data length as the minimum effective burst transfer data length (S15), and terminates the minimum effective burst transfer data length determination processing (S18).

Meanwhile, if, in step S14, the burst transfer data length is equal to the command data transfer length (S14: YES), the CPU 20 in the high-speed device 2 sets the maximum burst transfer data length for the low-speed device to the minimum effective burst transfer data length (S17), and terminates the minimum effective burst transfer data length determination processing (S18).

If, in step 13, the write performance is equal to or higher than the data transfer speed of the low-speed interface connected to each write stream target low-speed device (S13: YES), the CPU 20 in the high-speed device 2 sets the burst transfer data length to be half the current burst transfer data length (S16), then measures the write performance again (S12).

The minimum effective burst transfer data length set in step S15 or S17 is registered in the ‘minimum effective burst transfer data length’ field 26B in the burst transfer data length management table 26.

(1-5-3) Transferable Burst Transfer Data Length Determination Processing

Next, “transferable burst transfer data length determination processing” for determining the transferable burst transfer data length in light of response time, or the time taken from when the high-speed device 2 issues a write command until receiving an FCP_XFER_RDY notice will be described. The transferable burst transfer data length determination processing is executed by the CPU 20 in the high-speed device 2 based on the transferable burst transfer data length determination program 24.

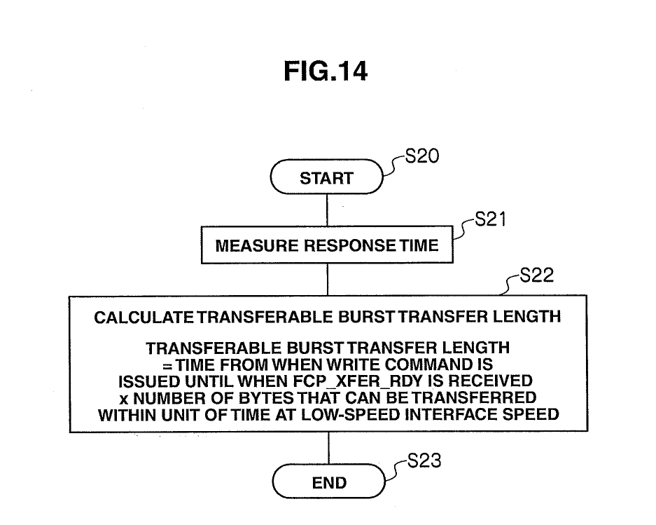

More specifically, as shown in FIG. 14, the CPU 20 in the high-speed device 2 starts the transferable burst transfer data length determination processing when the device is started up. (S20).

Next, the CPU 20 in the high-speed device 2 measures response time taken from when issuing a write command until when receiving an FCP_XFER_RFY notice (S21).

The CPU 20 in the high-speed device 2 calculates the burst transfer data length of data that can be transferred within the measured time (“transferable burst transfer data length”) (S22). The transferable burst transfer data length can be calculated by multiplying the response time by the number of bytes that can be transferred within a unit of time within the response time at the low-speed interface speed.

The CPU 20 in the high-speed device 2 registers the calculation result for the ‘transferable burst transfer data length’ field 26 in the burst transfer data length management table 26, and terminates the transferable burst transfer data length determination processing (S23).

(1-5-4) Multiple-Target Data Transfer Burst Transfer Data Length Determination Processing

“Multiple-target data transfer burst transfer data length determination processing” is executed by the CPU 20 in the high-speed device 2 based on the multiple-target data transfer burst transfer data length program 25.

More specifically, if any write stream is being executed (S2: YES), the CPU 20 in the high-speed device 2 starts the multiple-target data transfer burst transfer data length determination processing (S30).

The CPU 20 refers to the burst transfer data length management table 26 and checks whether or not there has been any external input of the burst transfer data length set for the low-speed device 6 with the relevant device number (S31).

If there has been no external input of the burst transfer data length set for the low-speed device 6 with the relevant device number (S31: NO), the CPU 20 in the high-speed device 2 sets the number of write stream target devices to N (S32). N is an integer of 2 or larger.

The CPU 20 in the high-speed device 2 checks whether or not the minimum effective burst transfer data length used when the number of write stream target devices is N is longer than the transferable burst transfer data length (S33).

If the minimum effective burst transfer data length when the number of write stream target devices is N is longer than the transferable burst transfer data length (S33: YES), the CPU 20 in the high-speed device 2 sets the minimum effective burst transfer data length when the number of write stream target devices is N to the burst transfer data length for the low-speed device 6 of the relevant device number (S34).

As an example, refer to relevant entries in the burst transfer data length management table 26 shown in FIG. 3 corresponding to the low-speed device of device number 1, where the number of write stream target devices is 2. When the number of write stream target devices is 2, the minimum effective burst transfer data length is 64 KB and the transferable burst transfer data length is 48 KB. Since the minimum effective burst transfer data length is longer than the transferable burst transfer data length, the minimum effective burst transfer data length of 64 KB is set as the burst transfer data length for the low-speed device of device number 1.

Meanwhile, if the minimum effective burst transfer data length when the number of write stream target devices is N is equal to or shorter than the transferable burst transfer data length (S33: NO), the transferable burst transfer data length is set to the burst transfer data length for the low-speed device 6 of the relevant device number (S35).

As an example, refer to relevant entries in the burst transfer data length management table 26 corresponding to the low-speed device of device number 1, where the number of write stream target devices is 3. When the number of write stream target devices is 3, the minimum effective burst transfer data length is 32 KB and the transferable burst transfer data length is 48 KB. Since the minimum effective burst transfer data length is shorter than the transferable burst transfer data length, the transferable burst transfer data length of 48 KB is set to the burst transfer data length for the low-speed device of device number 1.

If, in step S31, there has been external input of the burst transfer data length set for the low-speed device 6 of the relevant device number (S31: YES), the CPU 20 in the high-speed device 2 sets the externally input burst transfer data length as the burst transfer data length for the low-speed device 6 of the relevant device number 6 (S36).

The CPU 20 in the high-speed device 2, after setting either the minimum effective burst transfer data length, the transferable burst transfer data length, or the externally input burst transfer data length as the burst transfer data length for the low-speed device (S34, S35, or S36), terminates the multiple-target data transfer burst transfer data length determination processing (S37).

The high-speed device 2 then transfers, to the low-speed devices 6, data of the burst transfer data length set for each target device, and adjusts the value the low-speed device 6 notifies the high-speed device 2 of as the burst transfer data length (data transfer length) of data that can be transferred at a one-time burst transfer. By doing so, the high-speed device 2 can be controlled so that the high-speed device 2 can transfer data to the next target device, and multiple-target data transfer can be performed during the processing executed by the target devices without generating a no-transfer time or transfer start waiting time.

(1-6) Advantage of First Embodiment

With this embodiment, an optimum burst transfer data length (data transfer length) for multiple-target data transfer can be set by fully utilizing the higher-speed interface bandwidth even when data is transferred between devices that execute different data speed processing, and therefore data transfer-related performance can be improved.

Moreover, with this embodiment, a control unit provided in an initiator device can set optimum data transfer length according to the status of data transfer from the initiator device to target devices.

### (2) Second Embodiment

(2-1) Transfer System Configuration

The transfer system in the second embodiment will be described below.

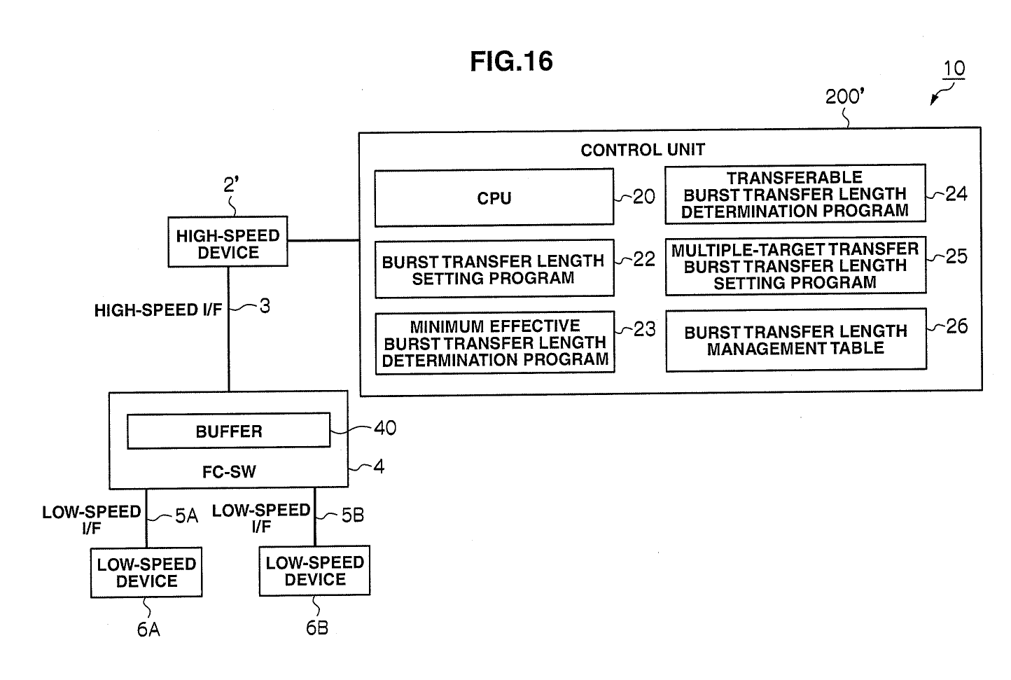

Referring to FIG. 16, the reference number 10 denotes the entire transfer system in the second embodiment.

The transfer system 10 in this embodiment includes a high-speed device 2′ as an initiator device and low-speed devices 6 as target devices.

In the transfer system 10 in this embodiment, a high-speed device 2′ connected to a control unit 200′ is connected to a switch 4 having a buffer 40 via a high-speed interface 3 that enables high-speed data transfer, and the switch 4 is connected to low-speed devices 6A and 6B respectively via low-speed interfaces 5A and 5B each transferring data at low speed.

The control unit 200′ is a controller that can control the length of data transferred from the high-speed device 2′ or the low-speed devices 6 and has the CPU 20, the programs 22 to 25, and the burst transfer data length management table 26 explained in the first embodiment.

The high-speed device 2′ is a device for controlling data I/O, and can execute data processing at high speed.

The CPU 20 in the control unit 200′ reads the stored programs 22 to 25 and the burst transfer data length management table 26, and executes various types of processing explained in the first embodiment for setting an optimum data transfer length.

The CPU 20 in the control unit 200′ specifies an optimum data transfer length to the high-speed device 2′ and the low-speed devices 6A and 6B based on the execution result of the processing. Based on the that, the high-speed device 2′ and the low-speed devices 6A and 6B transfer data of the optimum data transfer length via the switch 4.

Since other features in this embodiment are the same as those in the first embodiment, their explanation has been omitted.

(2-2) Advantage of the Second Embodiment

With this embodiment, an optimum data transfer length (burst transfer data length) can be set by fully utilizing the higher-speed interface bandwidth even when data is transferred between devices that execute different data speed processing. Accordingly, the data transfer-related performance can be improved.

Also, with this embodiment, a control unit provided in an initiator device can set the optimum data transfer length according to the data transfer status.

### (3) Third Embodiment

The transfer system in the third embodiment will be described below.

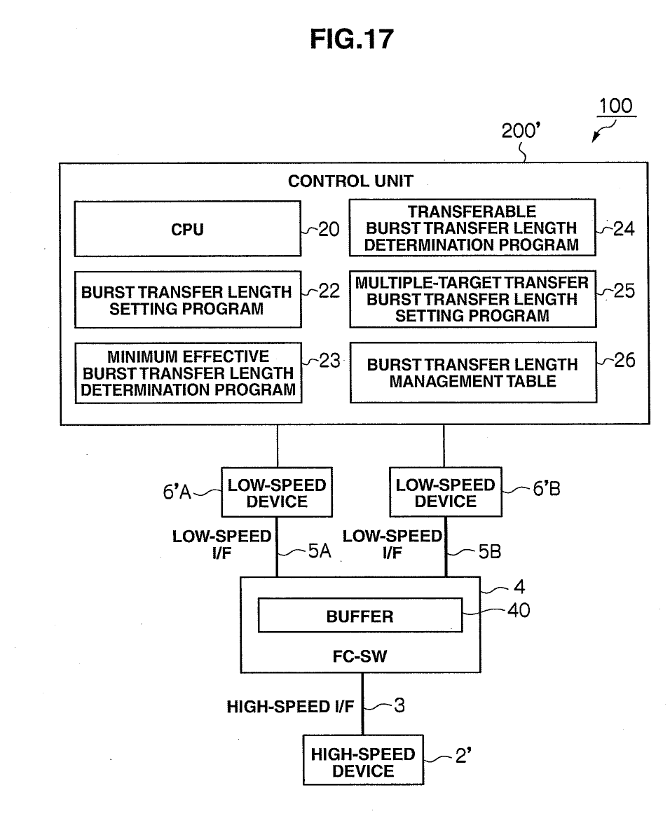

Referring to FIG. 17, reference number 100 denotes the entire transfer system in the third embodiment.

The transfer system 100 in this embodiment includes low-speed devices 6 as initiator devices and a high-speed device 2 as a target device.

In the system 100, low-speed devices 6′A and 6′B connected to a control unit 200′ are respectively connected to a switch 4 having a buffer 40 via low-speed interfaces 5A and 5B, which each transfer data at low speed, and the switch 4 is connected to a high-speed device 2′ via a high-speed interface 3 that enables high-speed data transfer.

The control unit 200′ is a controller that can control the length of data transferred from the high-speed device 2 or low-speed devices 6, and has the CPU 20, the various programs 22 to 25, and the burst transfer data length management table 26 explained in the first embodiment.

The low-speed devices 6′A and 6′B are devices for controlling data I/O, and can execute data processing at low speed.

The high-speed device 2′ is a device for controlling data I/O, and can execute data processing at high speed.

The CPU 20 in the control unit 200′ reads the stored programs 22 to 25 and the burst transfer data length management table 26 and executes various types of processing explained in the first embodiment for setting an optimum data transfer length.

The CPU 20 in the control unit 200′ specifies an optimum data transfer length to the low-speed devices 6′A and 6′B and the high-speed device 2′ based on the execution result of the processing. Based on the specification, the high-speed device 2 and the low-speed devices 6′A and 6′B transfer, via the switch 4, data of the optimum data transfer length.

Since other features in this embodiment are the same as those explained in the first embodiment, their explanation has been omitted.

(3-2) Advantage of Third Embodiment

With this embodiment, the optimum data transfer length (burst transfer data length) can be set by fully utilizing the higher speed interface bandwidth even when data is transferred between devices that execute data processing at different speed. Accordingly, the data transfer-related performance can be improved.

Also, with this embodiment, a control unit provided in an initiator device can set the optimum data transfer length according to the data transfer status.

### (4) Other Embodiments

In the above described embodiments, the initiator is a high-speed device (or low-speed device) and the target device(s) is a low-speed device(s) (or high-speed device(s)). However, devices of any type of data transfer speed can be used if the multiple-target data transfer can be performed between the initiator device and the target device(s).

Although the control unit is provided as memory in an initiator device or externally connected in the above described embodiments, the control unit may also be provided as separate hardware.

Although the minimum effective burst transfer data length determination unit (minimum effective burst transfer data length determination program) and the transferable burst transfer data length determination unit (transferable burst transfer data length determination program) are provided in the control unit in the above described embodiments, they may also be separate hardware.

The invention can be widely used in data transfer systems including one or more initiator devices and one or more target devices that execute data processing at different speeds, or other kinds of transfer systems.

What is claimed is:

1. A transfer system comprising:
an initiator device;
a plurality of target devices; and
a switch for switching targets of data transfer between the initiator device and the plural target devices,
wherein either the initiator device or the plurality of target devices is connected to the switch via a high-speed interface, and the other is connected to the switch via a low-speed interface, and
the initiator device includes a control unit for determining, according to the status of data transfer to the target device(s) other than a first target device in the target devices, the data transfer length used for data transfer to the first target device when data is transferred between the initiator device and the first target device.

2. The transfer system according to claim 1, wherein the control unit determines, based on the status of data transfer to the target device(s) other than the first target device, the data transfer length used for data transfer to the first target device.

3. The transfer system according to claim 1, wherein the control unit includes: a minimum effective data transfer length determination unit for determining, based on data transfer-related performance between the initiator device and the first target device and data transfer speed of the low-speed interface to each of the target device(s) targeted by multiple-target data transfer from the initiator device, a minimum effective data transfer length for maintaining data transfer-related performance when data is being transferred to the other target devices; and a transferable data transfer length determination unit for determining the length of data that can be transferred from the initiator device within a response time that is a period of time from when the initiator device issues a command until when the first target device, having received the issued command, notifies the initiator of the data transfer size, and
the length of data transferred to the first target device is determined based on the minimum effective data transfer length determined by the minimum effective data transfer length determination unit and the data transfer length determined by the transferable data transfer length determination unit.

4. The transfer system according to claim 3, wherein the control unit includes a management table for managing the minimum effective data transfer length determined by the minimum effective data transfer length determination unit and the data transfer length determined by the transferable data transfer length determination unit.

5. The transfer system according to claim 3, wherein the control unit compares the minimum effective data transfer length determined by the minimum effective data transfer length determination unit with the data transfer length determined by the transferable data transfer length determination unit, and sets, based on the comparison, the longer one as the data transfer length for data transfer to the first target device.

6. An initiator device comprising a control unit connected, via a high-speed or low-speed interface, to a switch for switching targets that are plural target devices data is transferred to, the control unit determining, according to the status of data transfer to the target device(s) other than a first target device in the target devices, the data transfer length for data transfer to the first target device when data is transferred to the first target device.

7. The initiator device according to claim 6, wherein the control unit determines, based on information for determining the data transfer length for multiple-target data transfer, the data transfer length for data transfer to the first target device when data is being transferred to the target device(s) other than the first target device.

8. The initiator device according to claim 6, wherein the control unit includes: a minimum effective data transfer length determination unit for determining, based on data transfer-related performance to the first target device and data transfer speed of the low-speed interface to each of target device(s) targeted by multiple-target data transfer, a minimum effective data transfer length for maintaining data transfer-related performance when data is being transferred to the target device(s) other than the first target device; and a transferable data transfer length determination unit for determining the data transfer length for data transfer to the first target device within a response time that is a period of time from when the initiator device issues a command until when the first target device, having received the issued command, notifies the initiator device of the data transfer size, and
wherein the data transfer length for data transfer to the first target device is determined based on the minimum effective data transfer length determined by the minimum effective data transfer length determination unit and the data transfer length determined by the transferable data transfer length determination unit.

9. The initiator device according to claim 8, wherein the control unit includes a management table for managing the minimum effective data transfer length determined by the minimum effective data transfer length determination unit and the data transfer length determined by the transferable data transfer length determination unit.

10. The initiator device according to claim 8, wherein the control unit compares the minimum effective data transfer length determined by the minimum effective data transfer length determination unit with the data transfer length determined by the transferable data transfer length determination unit, and sets, based on the comparison, the longer one as the data transfer length for data transfer to the first target device.

11. A method for transferring data between an initiator device and plural target devices, either the initiator device or the target devices being connected, via a high-speed interface, to a switch for switching targets of data transfer between the initiator and the target devices, and the other being connected to the switch via a low-speed interface,
the method comprising:
controlling data transfer by determining, when data is transferred between the initiator device and a first target device in the plural target devices, the data transfer length for data transfer to the first target device according to the status of data transfer to the target device(s) other than the first target device.

12. The data transfer method according to claim 11, the controlling step also including determining, based on information for determining the data transfer length for multiple-target data transfer, the data transfer length for data transfer to the first target device when data is being transferred to the other target device(s).

13. The data transfer method according to claim 11, the controlling step also including:
determining the minimum effective data transfer length for maintaining data transfer-related performance based on data transfer-related performance between the initiator device and the first target device and data transfer speed of a low-speed interface for each of the target devices targeted by multiple-target data transfer from the initiator device; and
determining the transferable data transfer length that is the length of data able to be transferred from the initiator device within a response time that is a period of time from when the initiator device issues a command until when the first target device, having received the issued command, notifies the initiator device of the data transfer size,
wherein the data transfer length of data transferred to the target device is determined based on the data transfer length determined based on the minimum effective data transfer length determined in the minimum effective data transfer length determining step and the data transfer length determined in the transferable transfer data length determining step.

14. The data transfer method according to claim 13, wherein in the controlling step, the data transfer length is determined based on a management table for managing the minimum effective data transfer length determined in the minimum effective data transfer length determining step and the data length determined in the transferable data transfer length determining step.

15. The data transfer method according to claim 13, wherein in the controlling step, the minimum effective data transfer length determined in the minimum effective data transfer length determining step is compared with the data transfer length determined in the transferable data transfer length determining step, and the longer one is set, based on the comparison, as the data transfer length of data transferred to the first target device.
